(19) United States
(12) Patent Application Publication
(10) Pub. No.: US 2011/0265884 A1
(43) Pub. Date: Nov. 3, 2011

(54) TWIN CHAMBER PROCESSING SYSTEM WITH SHARED VACUUM PUMP

(75) Inventors: MING XU, San Jose, CA (US); ANDREW NGUYEN, San Jose, CA (US); EVANS LEE, Milpitas, CA (US)

(73) Assignee: APPLIED MATERIALS, INC., Santa Clara, CA (US)

(21) Appl. No.: 12/907,952

(22) Filed: Oct. 19, 2010

Related U.S. Application Data
(60) Provisional application No. 61/330,105, filed on Apr. 30, 2010.

(51) Int. Cl. F15D 1/00

(52) U.S. Cl. 137/14; 137/565.23

(57) ABSTRACT

Methods and apparatus for twin chamber processing systems are disclosed, and, in some embodiments, may include a first process chamber having a first vacuum pump to maintain a first operating pressure in a first processing volume selectively isolatable by a first gate valve disposed between the first processing volume and the first vacuum pump; a second process chamber having a second vacuum pump for maintaining a second operating pressure in a second processing volume selectively isolatable by a second gate valve disposed between the second processing volume and the second vacuum pump; and a shared vacuum pump coupled to the first and second processing volumes to reduce a pressure in each processing volume below a critical pressure level, wherein the shared vacuum pump can be selectively isolated from any of the first or second process chambers or the first or second vacuum pumps.

### CROSS-REFERENCE TO RELATED APPLICATIONS

This application claims benefit of U.S. provisional patent application Ser. No. 61/330,105, filed Apr. 30, 2010, which is herein incorporated by reference.

### FIELD

Embodiments of the present invention generally relate to substrate processing systems, and more specifically with methods and apparatus for a twin chamber processing systems.

### BACKGROUND

Processing systems, for example, such as cluster tool having multiple process chambers on a shared transfer chamber are utilized to reduce system and manufacturing costs and improve process throughput. However, conventional process chambers are independently configured with the process resources necessary to facilitate performing the particular process therein. Such systems are costly to own and operate.

Therefore, the inventors have developed a system where system costs can be further reduced by sharing resources between process chambers. Specifically, the inventors have developed a twin chamber processing system having shared resources, for example, a shared vacuum pump, a shared gas panel, or the like to reduce system and substrate manufacturing costs. Unfortunately, as a result of sharing chamber resources, the inventors have further discovered that certain chamber processes, such as pumping down, venting, or cyclically purging a first process chamber of the twin chamber processing system are dependent on the conditions in a second process chamber of the twin chamber processing system.

Accordingly, the inventors provide methods of performing chamber processes in each chamber of the twin chamber processing system using shared chamber resources.

### SUMMARY

Methods and apparatus for a twin chamber processing system with a shared vacuum pump are disclosed herein. In some embodiments, a twin chamber processing system may include a first process chamber having a first vacuum pump for maintaining a first operating pressure in a first processing volume of the first process chamber, wherein the first processing volume can be selectively isolated by a first gate valve disposed between the first processing volume and a low pressure side of the first vacuum pump; a second process chamber having a second vacuum pump for maintaining a second operating pressure in a second processing volume of the second process chamber, wherein the second processing volume can be selectively isolated by a second gate valve disposed between the second processing volume and a low pressure side of the second vacuum pump; and a shared vacuum pump coupled to the first and second processing volumes for reducing a pressure in each processing volume below a critical pressure level prior to opening the first and second gate valves, wherein the shared vacuum pump can be selectively isolated from any of the first process chamber, the second process chamber, the first vacuum pump, or the second vacuum pump. In some embodiments, the twin chamber processing system further includes a shared gas panel coupled to each of the first process chamber and the second process chamber for providing one or more process gases to the first and second process chambers.

In some embodiments, a method of reducing pressure in each chamber of a twin chamber processing system to a desired operating pressure may include reducing a pressure of a first processing volume of a first process chamber of a twin chamber processing system below a critical pressure level using a shared vacuum pump coupled to the first processing volume and a second processing volume of a second process chamber of the twin chamber processing system, wherein the second processing volume is isolated from the first processing volume and the shared vacuum pump; reducing a pressure in the first processing volume from below the critical pressure level to a first operating pressure using a first vacuum pump coupled to the first processing volume after the first processing volume is isolated from the shared vacuum pump; opening the second processing volume to the shared vacuum pump after isolating the first processing volume having a pressure below the critical pressure level from the shared vacuum pump; reducing the second processing volume of the second process chamber below the critical pressure level using the shared vacuum pump; and reducing a pressure in the second processing volume from below the critical pressure level to a second operating pressure using a second vacuum pump coupled to the second processing volume after isolating the second processing volume from the shared vacuum pump.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic top view of a processing system in accordance with some embodiments of the present invention.

FIG. 2 depicts a schematic side view of a twin chamber processing system in accordance with some embodiments of the present invention.

FIG. 3 depicts a flow chart for a method of reducing pressure in each chamber of a twin chamber processing system in accordance with some embodiments of the present invention.

FIG. 4 depicts a flow chart for a method of venting each chamber of a twin chamber processing system in accordance with some embodiments of the present invention.

FIG. 5 depicts a flow chart for a method of purging each chamber of a twin chamber processing system in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Methods and apparatus for a twin chamber processing system are disclosed herein. The inventive twin chamber processing system advantageously combines resources, for example, such as a shared vacuum pump, shared gas panel or the like, to reduce system costs while maintaining processing quality in each chamber of the twin chamber processing system. Further, the inventive methods advantageous control operation of chamber processes, such as reducing pressure, venting, purging or the like, when shared resources are used between each chamber of the twin chamber processing system.

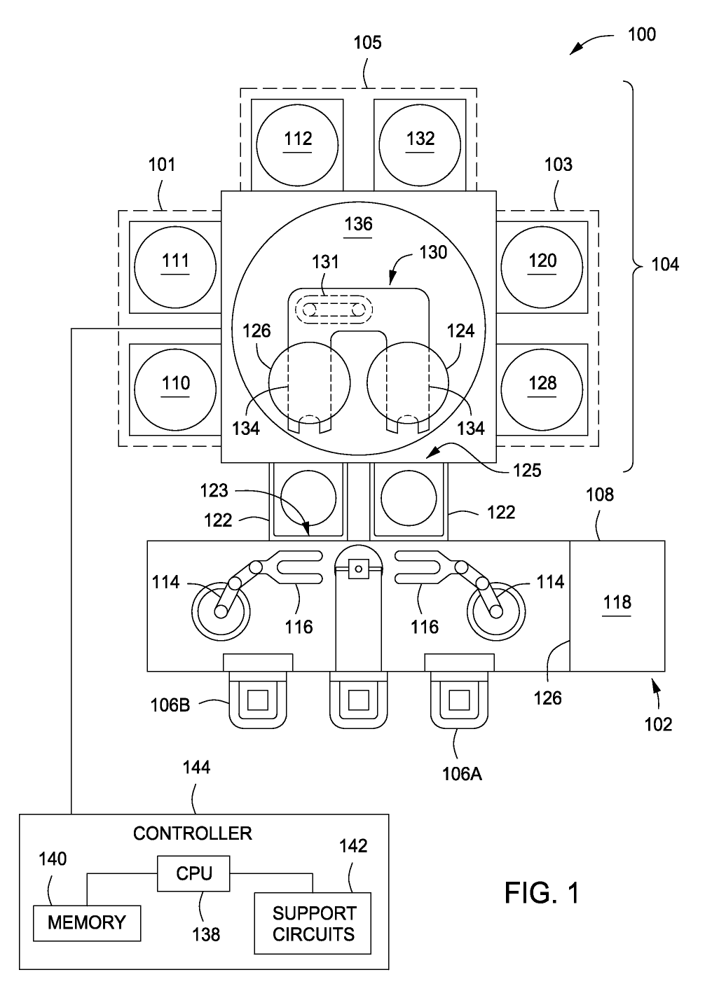

A twin chamber processing system disclosed herein may be part of a cluster tool having several twin chamber processing systems coupled thereto, for example, such as a processing system 100 illustrated in FIG. 1. Referring to FIG. 1, in some embodiments, the processing system 100 may generally comprise a vacuum-tight processing platform 104, a factory interface 102, one or more twin chamber processing systems 101, 103, 105 and a system controller 144. Examples of processing systems that may be suitably modified in accordance with the teachings provided herein include the Centura® integrated processing system, one of the PRODUCER® line of processing systems (such as the PRODUCER® GT™), ADVANTEDGE™ processing systems, or other suitable processing systems commercially available from Applied Materials, Inc., located in Santa Clara, Calif. It is contemplated that other processing systems (including those from other manufacturers) may be adapted to benefit from the invention. Another example of a twin chamber processing system is described in U.S. Provisional Patent Application Ser. No. 61/330,156, filed Apr. 30, 2010, by Ming Xu et al., and entitled, “Twin Chamber Processing System.”

The platform 104 includes one or more twin chamber processing systems 101, 103, 105 (three shown in FIG. 1), wherein each twin chamber processing system includes two process chambers (e.g., 110 and 111, 112 and 132, and 120 and 128). The platform further includes at least one load-lock chamber (two shown in FIG. 1) 122 that are coupled to a vacuum substrate transfer chamber 136. The factory interface 102 is coupled to the transfer chamber 136 via the load lock chambers 122.

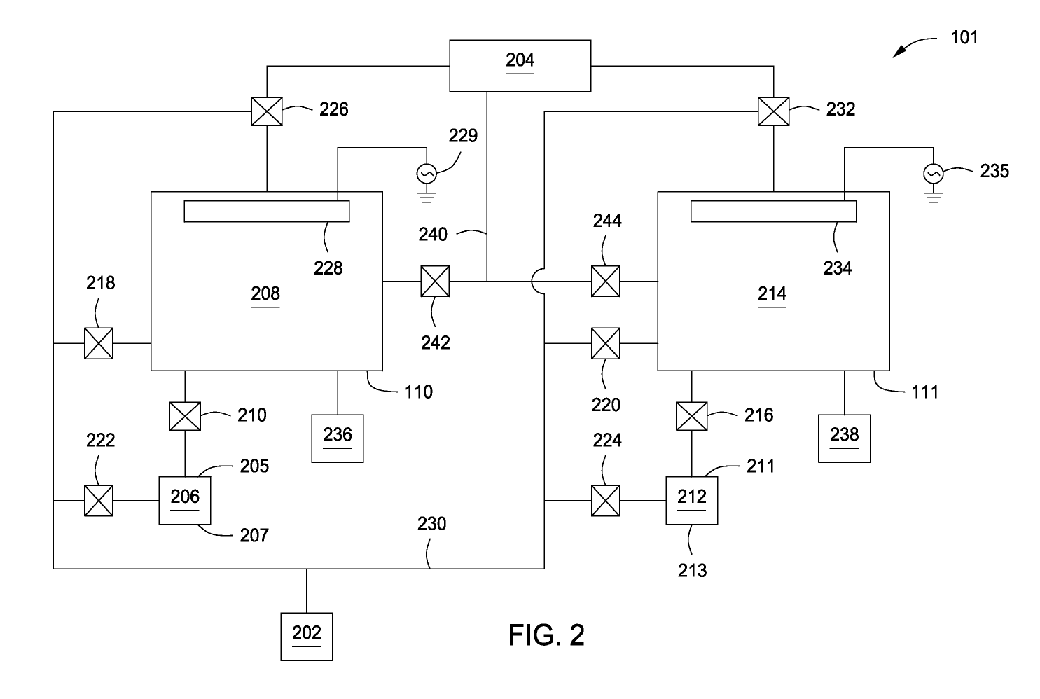

Each twin chamber processing system 101, 103, 105 includes independent processing volumes that may be isolated from each other. Each twin chamber processing system 101, 103, 105 may be configured to share resources (e.g., process gas supply, vacuum pump, or the like) between each process chamber of the twin chamber processing system as discussed below and illustrated in FIG. 2.

The factory interface 102 may comprise at least one docking station 108 and at least one factory interface robot (two shown in FIG. 1) 114 to facilitate transfer of substrates. The docking station 108 may be configured to accept one or more (two shown in FIG. 1) front opening unified pods (FOUPs) 106A-B. The factory interface robot 114 may comprise a blade 116 disposed on one end of the robot 114 configured to transfer the substrate from the factory interface 102 to the processing platform 104 for processing through the load lock chambers 122. Optionally, one or more metrology stations 118 may be connected to a terminal 126 of the factory interface 102 to facilitate measurement of the substrate from the FOUPs 106A-B.

Each of the load lock chambers 122 may include a first port 123 coupled to the factory interface 102 and a second port 125 coupled to the transfer chamber 136. The load lock chambers 122 may be coupled to a pressure control system (not shown) which pumps down and vents the load lock chambers 122 to facilitate passing the substrate between the vacuum environment of the transfer chamber 136 and the substantially ambient (e.g., atmospheric) environment of the factory interface 102.

The transfer chamber 136 has a vacuum robot 130 disposed therein. The vacuum robot 130 may have one or more transfer blades 134 (two shown in FIG. 1) coupled to a movable arm 131. For example, in some embodiments, where twin chamber processing systems are coupled to the transfer chamber 136 as shown, the vacuum robot 130 may have two parallel blades 134 configured such that the vacuum robot 130 may simultaneously transfer two substrates 124, 126 between the load lock chambers 122 and the process chambers of a twin chamber processing system, for example, process chambers 110, 111 of the twin chamber processing system 101.

The process chambers 110, 111 or 112, 132 or 120, 128 of each twin chamber processing system 101, 103, 105 may be any type of process chamber utilized in substrate processing, for example, such as etch chambers, deposition chambers, or the like. In some embodiments, the process chambers, for example process chambers 110, 111, of each twin chamber processing system, for example twin chamber processing system 101 are configured for the same function, for example, etching. For example, in embodiments where each process chamber of a twin chamber processing system is an etch chamber, each process chamber may include a plasma source, for example, an inductive or capacitively coupled plasma source, a remote plasma source or the like. Further, each process chamber of a twin chamber processing system may use a halogen-containing gas, for example, provided by a shared gas panel (as discussed below), to etch substrates (e.g., substrates 124, 126) disposed therein. Examples of halogen-containing gas include hydrogen bromide (HBr), chlorine (Cl₂), carbon tetrafluoride (CF₄), and the like. For example, after etching the substrates 124, 126, halogen-containing residues may remain on the substrate surface. The halogen-containing residues may be removed by a thermal treatment process in the load lock chambers 122, or by other suitable means.

FIG. 2 depicts a schematic side view of a twin chamber processing system, for example twin chamber processing system 101, in accordance with some embodiments of the present invention. The twin chamber processing system 101 includes the process chambers 110, 111, wherein the process chambers 110, 111 share resources, for example, such as a shared vacuum pump 202 and a shared gas panel 204 as shown in FIG. 2. In some embodiments, each twin chamber processing system coupled to the processing system 100 may be similarly configured.

The process chamber 110 (e.g., a first process chamber) has a first processing volume 208 that includes a first substrate support disposed therein to support a first substrate (not shown). The process chamber 110 further includes a first vacuum pump 206 for maintaining a first operating pressure in the first processing volume 208. The first vacuum pump 206 may be, for example, a turbomolecular pump or the like. The first vacuum pump 206 may include a low pressure side 205 proximate the first processing volume 208 and a high pressure side 207 which may be selectively coupled to the shared vacuum pump 202 as discussed below. The first vacuum pump 206 may be selectively isolated from the first processing volume 208 by a first gate valve 210 disposed between the first processing volume 208 and the first vacuum pump 206, for example proximate the low pressure side 205 of the first vacuum pump 206.

The process chamber 111 (e.g., a second process chamber) of the twin chamber processing system 101 includes a second processing volume 214 having a second substrate support disposed therein to support a second substrate. The process chamber 111 further includes a second vacuum pump 212 for maintaining a second operating pressure in the second processing volume 214. The second vacuum pump 212 may be, for example, a turbomolecular pump or the like. The second vacuum pump 212 may include a low pressure side 211 proximate the second processing volume 214 and a high pressure side 213 which may be selectively coupled to the shared vacuum pump 202 as discussed below. The second vacuum pump 212 may be selectively isolated from the second processing volume 214 by a second gate valve 216 disposed between the second processing volume 214 and the second vacuum pump 212, for example proximate the low pressure side 211 of the second vacuum pump 212.

The first and second processing volumes 208, 214 may be isolated from each other to facilitate substantially independent processing of substrates in each respective process chamber 110, 111. The isolated processing volumes of the process chambers within the twin chamber processing system advantageously reduces or eliminates processing problems that may arise due to multi-substrate processing systems where the processing volumes are fluidly coupled during processing. However, the twin chamber processing system further advantageously utilizes shared resources that facilitate reduced system footprint, hardware expense, utilities usage and cost, maintenance, and the like, while at the same time promoting higher substrate throughput. For example, shared hardware may include one or more of a process foreline and roughing pump, AC distribution and DC power supplies, cooling water distribution, chillers, multi-channel thermo controllers, gas panels, controllers, and the like.

The shared vacuum pump 202 may be coupled to any of the first and second processing volumes 208, 214 or the first and second vacuum pumps 206, 212 and selectively isolated therefrom. For example, the shared vacuum pump 202 may be coupled to the first and second processing volumes 208, 214 for reducing a pressure in each processing volume below a critical pressure level prior to opening the first and second gate valves 210, 216. For example, the critical pressure level may be a higher pressure than either of the first and second operating pressure provided by the first and second vacuum pumps 206, 212 respectively. However, the critical pressure level may be required for the first and second vacuum pumps 206, 212 to begin operation.

The shared vacuum pump 202 may be selectively coupled to the first processing volume 208 while bypassing the first vacuum pump 206 by a first roughing valve 218 disposed between the first processing volume 208 and the shared vacuum pump 202. For example, and as discussed in the methods below, the first vacuum pump 206 may be isolated from the first processing volume 208 by the first gate valve 210 while a pressure of the first processing volume 208 is lowered to below the critical pressure level, for example, suitable for operation of the first vacuum pump 206. Additional embodiments where the first vacuum pump 206 may be bypassed are also discussed below.

Similarly, the shared vacuum pump 202 may be selectively coupled to the second processing volume 214 while bypassing the second vacuum pump 212 by a second roughing valve 220 disposed between the second processing volume 214 and the shared vacuum pump 202. For example, and as discussed in the methods below, the second vacuum pump 212 may be isolated from the second processing volume 214 by the second gate valve 216 while a pressure of the second processing volume 214 is lowered to below the critical pressure level, for example, suitable for operation of the second vacuum pump 206. Additional method embodiments where the second vacuum pump 212 may be bypassed are also discussed below.

The shared vacuum pump 202 may be selectively coupled to the first vacuum pump 206 by a first isolation valve 222. For example, the first isolation valve 222 may be disposed between the high pressure 207 of the first vacuum pump 206 and the shared vacuum pump 202. In some embodiments, for example when the first vacuum pump 206 is in operation, the first isolation valve is open to allow gases or the like removed from the first processing volume 208 by the first vacuum pump 206 to be exhausted from the high pressure side 207 of the first vacuum pump 206 to the shared vacuum pump 202.

Similarly, the shared vacuum pump 202 may be selectively coupled to the second vacuum pump 212 by a second isolation valve 224. For example, the second isolation valve 224 may be disposed between the high pressure 213 of the second vacuum pump 212 and the shared vacuum pump 202. In some embodiments, for example when the second vacuum pump 212 is in operation, the second isolation valve is open to allow gases or the like removed from the second processing volume 214 by the second vacuum pump 212 to be exhausted from the high pressure side 213 of the second vacuum pump 212 to the shared vacuum pump 202.

The shared gas panel 204 may be coupled to each of the process chambers 110, 111 for providing one or more process gases to the first and second processing volumes 208, 214. For example, the shared gas panel may include one or more gases sources (not shown), for example where a gas from each gas source is metered out to each process chamber by one or more flow controllers, such as a mass flow controller, flow ratio controller or the like. Each gas source may be provided to each processing volume independently or to both processing volumes simultaneously, for example, to perform the same process in both process chambers 110, 111 simultaneously. As used herein, simultaneously means that the processes being performed in the two processing volumes at least partially overlap, begin after both substrates are delivered to the two processing volumes, and end prior to removal of either substrate from either of the two processing volumes.

A first three-way valve 226 can be disposed between the shared gas panel 204 and the first processing volume 208 of the process chamber 110 to provide a process gas from the shared gas panel 204 to the first processing volume 208. For example, the process gas may enter the process chamber 110 at a first showerhead 228 or any suitable gas inlet(s) used for providing a process gas to a process chamber. Further, the first three-way valve 226 may divert the process gas from the shared gas panel 204 (e.g., bypassing the first processing volume 208) into a foreline conduit 230 coupled to the shared vacuum pump 202. Further, as shown, the foreline conduit 230 may couple the shared vacuum pump 202 to the high pressure side 207 of the first vacuum pump 206 and directly couple the shared vacuum pump 202 to the first processing volume 208.

The first showerhead 228 may include an electrode having a first RF power source 229 coupled thereto, for example, for striking a plasma in the first processing volume 208 from a process gas. Alternatively, the first RF power source 229 may be coupled to an electrode separate from the first showerhead 228 (not shown) or coupled to one or more inductive coils (not shown) disposed outside the first processing volume 208.

A second three-way valve 232 can be disposed between the shared gas panel and second processing volume 214 of the process chamber 111 to provide a process gas from the shared gas panel 204 to the second processing volume 21414. For example, the process gas may enter the process chamber 111 at a second showerhead 234 or any suitable gas inlet(s) used for providing a process gas to a process chamber. Further, the second three-way valve 232 may divert the process gas from the shared gas panel 204 (e.g., bypassing the second processing volume 214) into the foreline conduit 230 coupled to the shared vacuum pump 202. Further, as shown, the foreline conduit 230 may couple the shared vacuum pump 202 to the high pressure side 213 of the second vacuum pump 212 and directly couple the shared vacuum pump 202 to the second processing volume 214.

The second showerhead 234 may include an electrode having a second RF power source 235 coupled thereto, for example, for striking a plasma in the second processing volume 214 from a process gas. Alternatively, the second RF power source 235 may be coupled to an electrode separate from the second showerhead 234 (not shown) or coupled to one or more inductive coils (not shown) disposed outside the second processing volume 214.

The first and second three-way valves 226, 232 may operate in response to a process endpoint detected, for example, by a first endpoint detector 236 for detecting the process endpoint in the process chamber 110 and by a second endpoint detector 238 for detecting the process endpoint in the process chamber 111. For example, a controller, for example such as the system controller 144 or a individual controller (not shown) coupled to one or more of the components of the twin chamber processing system 101, may be configured to receive a first signal from the first endpoint detector 236 when the process endpoint is reached in the process chamber 110 and to instruct the first three-way valve 226 to divert a process gas into the foreline conduit 230 if the process endpoint has not been reached in a process running in the process chamber 111. For example, although a process may be synchronized in each process chamber 110, 111 initially, the process may end at different times in each process chamber 110, 111 due to, for example, small variations in a substrate being processed, substrate temperature, plasma density or flux, or the like in each process chamber 110, 111. Similarly, the controller may be configured to receive a second signal form the second endpoint detector 238 when the process endpoint is reached in the process chamber 111 and to instruct the second three-way valve 232 to divert a process gas into the foreline conduit 230 if the process endpoint has not been reached in a process running in the process chamber 110.

Alternatively, and for example, the controller may, upon receiving the first signal from the first endpoint detector 236 that a process endpoint has been reached for a process being performed on a substrate in process chamber 110, turn off power to the RF power source 229 to terminate a plasma in the first processing volume 208. Further, the process gas may continue to flow into the first processing volume 208 after the RF power source 229 is turned off instead of being diverted by the three-way valve 226 when the process endpoint is reached. A similar alternative embodiment upon receiving the second signal from the second endpoint detector 238 may be performed in process chamber 111. Further, if a signal is received from either of the first or second endpoint detectors 236, 238, the controller may, in some embodiments, terminate the processes in both chambers regardless of whether the process endpoint is detected in both chambers. For example, if the first signal is received from the first endpoint detector 236 that a process endpoint has been reached in the process chamber 110, the controller may terminate the processes in both chambers 110, 111 even though the second signal has not been received from the second endpoint detector 238. Alternatively, if the first signal is received signaling a process endpoint has been reached in the process chamber 110, the controller may not take any action in either process chamber 110, 111 until the second signal is received signaling a process endpoint has been reached in the process chamber 111 as well.

Alternatively, a process need not be precisely synchronized in both process chambers 110, 111 and for example may begin in each chamber when a substrate has reached the appropriate process temperature or another similar process condition. Accordingly, when a process endpoint is reach in a given chamber, the process gas is diverted by a three-way valve into the foreline conduit 230 until the process endpoint is reached in the adjacent chamber prior to removing the substrates from the chambers 110, 111 or prior to beginning a further processing step.

The shared gas panel may further provide a gas for purging the process chambers 110, 111. For example, a vent line 240 may be selectively coupled to each of the first and second processing volumes 208, 214 directly (as shown). For example, the purge gas may include nitrogen (N₂), argon (Ar), helium (He), or the like. The purge gas may be selectively provided to the first processing volume 208 via a first purge valve 242 disposed between the shared gas panel 204 and the first processing volume 208. Similarly, the purge gas may be selectively provided to the second processing volume 214 via a second purge valve 244 disposed between the shared gas panel 204 and the second processing volume 214. Further, in applications where the purge gas is utilized to vent each process chamber 110, 111 to atmosphere, a vent (not shown), for example such as a valve or the like, may be provided for each chamber 110, 111 such that each chamber 110, 111 may be vented to atmosphere independently from the other chamber.

Returning to FIG. 1, the system controller 144 is coupled to the processing system 100. The system controller 144 controls the operation of the system 100 using a direct control of the process chambers 110, 111, 112, 132, 128, 120 of the system 100 or alternatively, by controlling individual controllers (not shown) associated with the process chambers 110, 111, 112, 132, 128, 120 and/or each twin chamber processing system 101, 103, 105 and the system 100. In operation, the system controller 144 enables data collection and feedback from the respective chambers and system controller 144 to optimize performance of the system 100.

The system controller 144 generally includes a central processing unit (CPU) 138, a memory 140, and support circuit 142. The CPU 138 may be one of any form of a general purpose computer processor that can be used in an industrial setting. The support circuits 142 are conventionally coupled to the CPU 138 and may comprise cache, clock circuits, input/output subsystems, power supplies, and the like. The software routines, such as a method 300, 400, or 500 described below for controlling one or more chamber processes, such as reducing pressure, venting or purging each chamber of a twin chamber processing system, when executed by the CPU 138, transform the CPU 138 into a specific purpose computer (controller) 144. The software routines may also be stored and/or executed by a second controller (not shown) that is located remotely from the system 100.

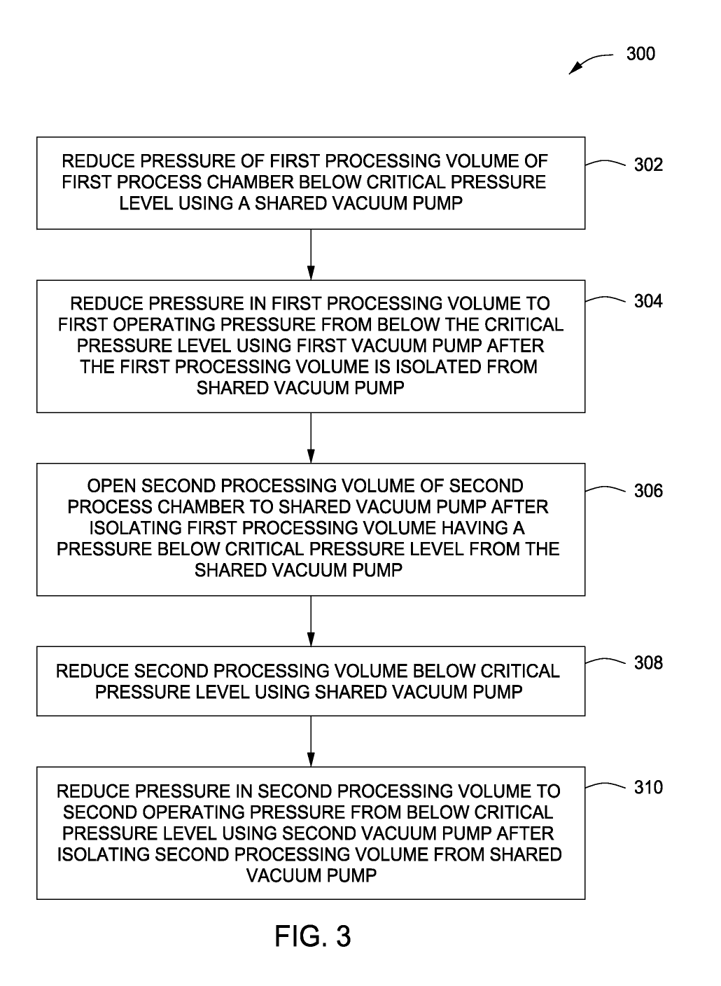

Methods 300, 400, and 500 for controlling various chamber processes of the process chambers of a twin chamber processing system are depicted in FIGS. 3-5, respectively, and described below with respect to the twin chamber processing system 101 depicted in FIG. 2.

FIG. 3 depicts a flow chart for a method of reducing pressure in each chamber of a twin chamber processing system in accordance with some embodiments of the present invention. For example, because the first and second processing volumes 208, 214 share a common vacuum pump, e.g., the shared vacuum pump 202, each processing volume may be selectively isolated from the shared vacuum pump 202 during pump down, for example, to prevent backflow into the other processing volume if the other processing volume is at a lower pressure.

Accordingly, the method 300 for reducing pressure in each process chamber 110, 111 of the twin chamber processing system 101 begins at 302 by reducing a pressure in the first processing volume 208 of the process chamber 110 to below a critical pressure level using the shared vacuum pump 202 while the second processing volume 214 of the processing chamber 110 is isolated from the shared vacuum pump 202. For example, at 302, the first and second gate valves 210, 216 and the second roughing and isolation valves 220, 224 may be closed. The first roughing valve 218 and the first isolation valve 222 may be open, for example, to allow the shared vacuum pump 202 to reduce a pressure in the first processing volume 208 and a pressure in the first vacuum pump 206 to below the critical pressure level. Further, at 302, the first and second vacuum pumps 206, 212 may be off.

At 304, and after the pressure in the first processing volume 208 is below the critical pressure level, the first roughing valve 218 is closed to isolate the first processing volume 208 from the shared vacuum pump 202. Next, the first vacuum pump 206 may be turned on and the first gate valve 210 may be opened to reducing the pressure in the first processing volume 208 to a first operating pressure using the first vacuum pump 206.

At 306, the second processing volume 214 may be opened to the shared vacuum pump 202 after isolating the first processing volume 208 from the shared vacuum pump 202 by closing the first roughing valve 218 when the first processing volume 208 has a pressure below the critical pressure level. For example, the second roughing valve 220 may be opened to reducing a pressure in the second processing volume 214 to below the critical pressure level. Further, the second isolation valve 224 may be opened to reduce a pressure in the second vacuum pump 212 below the critical pressure level prior to opening the second gate valve 216 and turning on the second vacuum pump 212.

At 308, after the pressure in the second processing volume 214 is below the critical pressure level, the second roughing valve 220 is closed to isolate the second processing volume 214 from the shared vacuum pump 202. Next, at 310, the pressure in the second processing volume 214 may be reduced from below the critical pressure level to a second operating pressure by turning on the second vacuum pump 212 and opening the second gate valve 216.

Upon completion of reducing the pressure in the second processing volume to the second operating pressure at 310, the process chambers 110, 111 may be at operating pressure and ready for performing a process, for example an etch process, on a substrate disposed in each process chamber 110, 111. In some embodiments, the processes may be synchronized such that process begins in both chambers 110, 111 when the last chamber has reached the desired operating pressure. Alternatively, the process may begin in either process chamber as soon as the desired operating pressure is reached, even if that is prior to the other process chamber reaching the desired operating pressure. As discussed above, process gases provided by the gas panel to the process chamber 110 during the process may be diverted to the foreline conduit 230 when a process endpoint is reached in the process chamber 110 while waiting for a process endpoint to be reached in the process chamber 111.

From a condition where both the process chambers 110, 111 of the twin chamber processing system 101 are at an operating pressure (e.g., a desired operating pressure), either or both chambers may be vented to atmosphere or purged, for example cyclically purged, as discussed below in methods 400 and 500 (for example, after a process is completed and prior to performing a subsequent process in the process chambers). Alternatively, the process chambers 110, 111 need not be at an operating pressure, and maybe at another pressure, such as below the critical pressure level or at atmosphere. However, the methods 400, 500 are illustratively discussed below beginning when the process chambers 110, 111 are at an operating pressure.

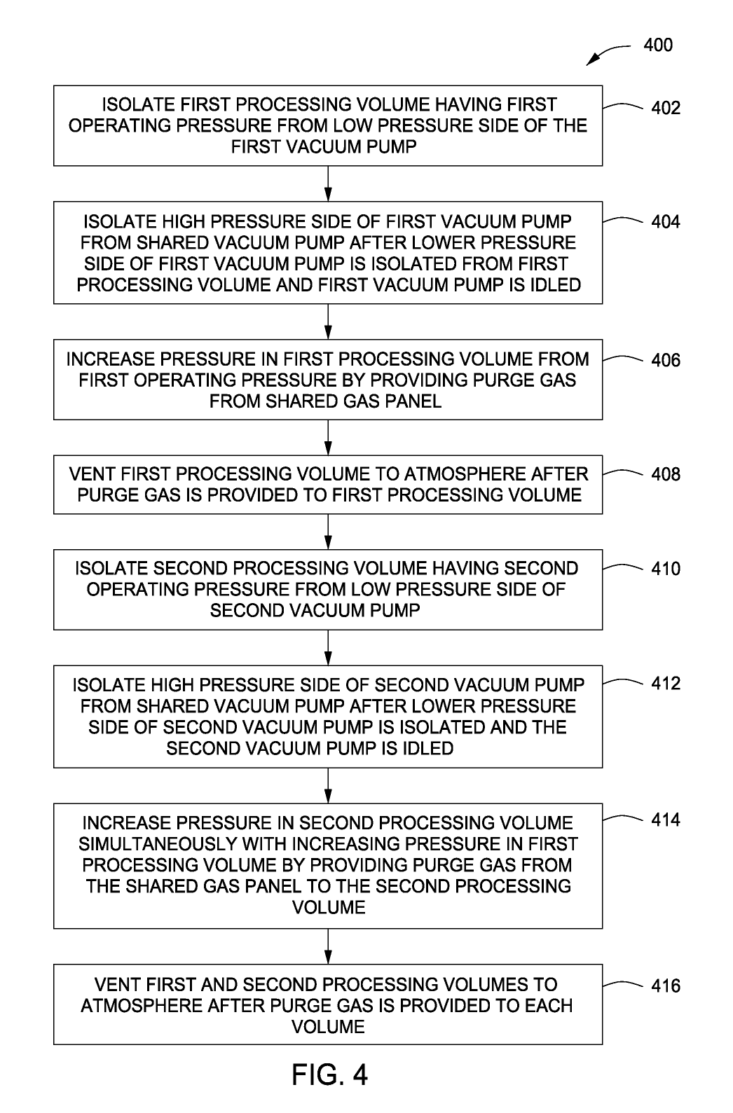

FIG. 4 depicts a flow chart for a method of venting each chamber of a twin chamber processing system in accordance with some embodiments of the present invention. The method 400 begins at 402 by isolating the first processing volume 208 of the process chamber 110 having the first operating pressure from the lower pressure side 205 of the first vacuum pump 206, for example, by closing the first gate valve 210. After the first gate valve 210 is closed, the first vacuum pump 206 may be idled.

At 404, and after the first gate valve 210 is closed and the first vacuum pump 206 is idled, the high pressure side 207 of the first vacuum pump 206 may be isolated from the shared vacuum pump 202. For example, the high pressure side 207 may be isolated from the shared vacuum pump 202 by closing the first isolation valve 222 which couples the high pressure side 207 of the first vacuum pump 206 to the foreline conduit 230.

At 406, the pressure in the first processing volume 208 may be increased from the first operating pressure by providing a purge gas from the shared gas panel 204. For example, the first purge valve 242 may be opened after the first gate valve 210 has been closed, the first vacuum pump 206 has been idled, and the first isolation valve has been closed at preceding method steps. The first gate valve 210 may remain closed, and the purge gas may be provided through the vent line 240 to the first processing volume 208 to increase the pressure in the first processing volume 208 from the first operating pressure. As discussed above, the vent line 240 need not be coupled directly to the first processing volume 208 and may be coupled by a similar vent line arrangement including a purge valve directly coupled to the high pressure side 207 of the first vacuum pump 206 for performing the method 400 at 406. In this alternatively embodiment of the vent line arrangement, the first gate valve 210 may be opened at 406 and the purge gas may be flowed through the idle first vacuum pump 206 into the first processing volume 208 to increase the pressure in the first processing volume 208.

Optionally, in some embodiments, the first processing volume 208 may be vented to atmosphere after the purge gas is provided to increase the pressure in the first processing volume 208 from the first operating pressure at 408. For example, the process chamber 110 may be vented for servicing, repair, or the like. For example, venting the chamber to atmosphere may be achieved by opening a vent (not shown) coupled to the process chamber 110 for opening the first processing volume 208 to atmosphere. Alternatively, venting of the first processing volume 208 may be achieved by opening a lid of the process chamber 110 or the like.

Alternatively, the method 400 may omit step 408 and proceed to 410 where the second processing volume 214 of the process chamber 111 having the second operating pressure may be isolated from the low pressure side 211 of the second vacuum pump 212, for example by closing the second gate valve 216. After the second gate valve 216 is closed, the second vacuum pump 212 may be idled.

At 412, and after the second gate valve 216 is closed and the second vacuum pump 212 is idled, the high pressure side 213 of the second vacuum pump 212 may be isolated from the shared vacuum pump 202. For example, the high pressure side 213 may be isolated from the shared vacuum pump 202 by closing the second isolation valve 224 which couples the high pressure side 213 of the second vacuum pump 212 to the foreline conduit 230.

At 414, the pressure in the second processing volume 214 may be increased from the second operating pressure by providing a purge gas from the shared gas panel 204. The pressure in the second processing volume 214 may be increased simultaneously with increasing the pressure in the first processing volume at 406. For example, to increase the pressure in the second processing volume the second purge valve 244 may be opened after the second gate valve 216 has been closed, the second vacuum pump 212 has been idled, and the second isolation valve has been closed. The second gate valve 216 may remain closed, and the purge gas may be provided through the vent line 240 into the second processing volume 214 via the second purge valve 244 to increase the pressure in the second processing volume 214 from the second operating pressure. As discussed above, the vent line 240 need not be directly coupled to second processing volume 214 and may be coupled by a similar vent line arrangement including a purge valve directly coupled to the high pressure side 213 of the second vacuum pump 212 for performing the method 400 at 414. In this alternatively embodiment of the vent line arrangement, the second gate valve 216 may be opened at 414 and the purge gas may be flowed through the idle second vacuum pump 216 into the second processing volume 214 to increase the pressure in the second processing volume 214.

At 416, the process chambers 110, 111 may be vented to atmosphere after purge gas is provided to each of the first and second processing volumes 208, 214. Alternatively, additional methods of venting the process chambers 110, 111 are possible. For example, the process chambers 110, 111 may be vented in series instead of simultaneously as discussed above. For example, after venting the process chamber 110 at 408, the method may proceed to 410 wherein a similar method as discussed in steps 402-408 are performed on the process chamber 111 to vent the process chamber 111 to atmosphere.

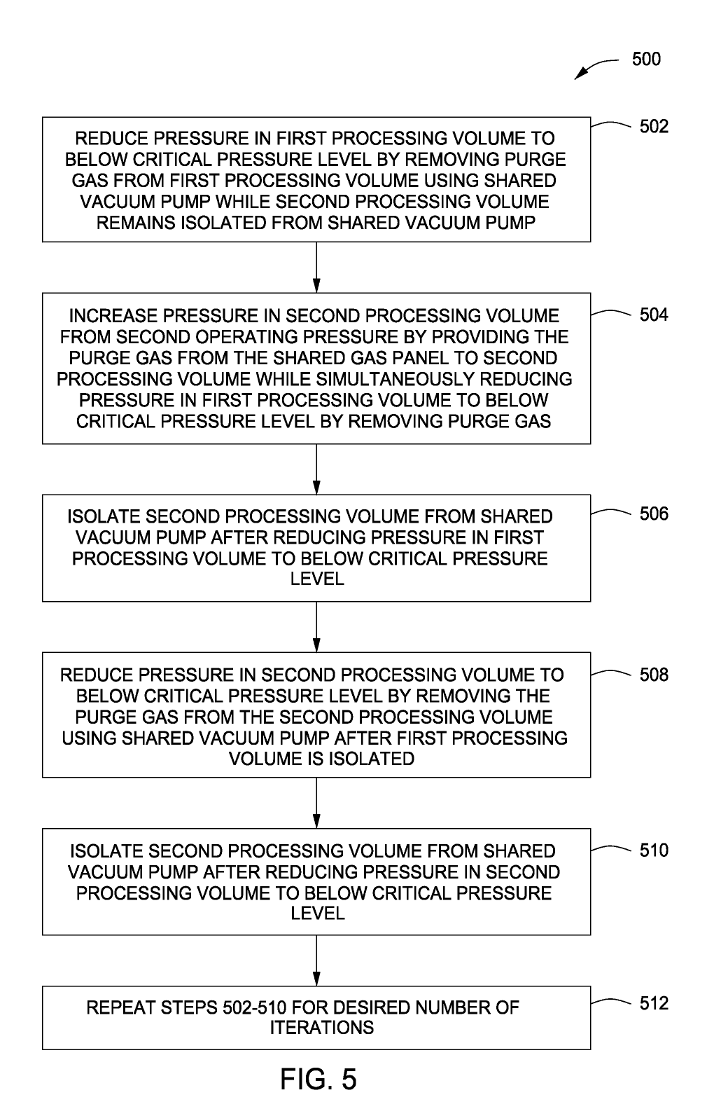

FIG. 5 depicts a flow chart for a method 500 of purging each chamber of a twin chamber processing system in accordance with some embodiments of the present invention. The method 500 begins after 412 of method 400 has been completed and 408 of method 400 has been omitted. Accordingly, prior to 502, the first processing volume 208 has been filled with the purge gas but not vented to atmosphere and the first purge valve 242 has been closed to prevent additional purge gas from entering the first processing volume 208. Further, the second gate valve 216 and the second isolation valve 224 have been closed, and the second vacuum pump 212 has been idled.

At 502, the pressure in the first processing volume 208 is reduced to below the critical pressure level by removing the purge gas from the first processing volume 208 using the shared vacuum pump 202 while the second processing volume 214 remains isolated from the shared vacuum pump 202. For example, the pressure in the first processing volume 208 may be reduced by opening the first roughing valve 218 to flow the purge gas into the foreline conduit 230 using the shared vacuum pump 202.

At 504, and simultaneously with reducing the pressure in the first processing volume 208 at 502, the pressure in the second processing volume 214 may be increased from the second operating pressure by providing the purge gas from the shared gas panel 204 to the second processing volume 214. As discussed above, the pressure in the second processing volume 214 may be increased by opening the second isolation valve 244 to provide the purge gas to the second processing volume 214.

At 506, after the pressure in the first processing volume 208 is reduced to below the critical pressure level, the first processing volume 208 may be isolated from the shared vacuum pump 202 by closing the first roughing valve 218.

At 508, and after the first processing volume 208 has been isolated at 506, the pressure in the second processing volume 214 may be reduced to below the critical pressure level by removing the purge gas from the second processing volume 214 using the shared vacuum pump 202. For example, the pressure in the second processing volume 214 may be reduced by opening the second roughing valve 220 to flow the purge gas into the foreline conduit 230 using the shared vacuum pump 202. Further, the second purge valve 244 may be closed prior to opening the second roughing valve 220 to the foreline conduit 230 to prevent additional purge gas from entering the second processing volume 214. In some embodiments, where the method 500 is repeated for as second iteration or any desired number of iterations, the purge gas may again be provided simultaneously to the first processing volume 208 as discussed above at 406 to increase the pressure in the first processing volume from below the critical pressure level while the pressure in the second processing volume 214 is being reduced at 508.

At 510, after the pressure in the second processing volume 214 is reduced to below the critical pressure level, the second processing volume 214 may be isolated from the shared vacuum pump 202 by closing the second roughing valve 220.

At 512, 502-510 may be repeated for a second iteration or any desired numbers of iterations to cycle purge each of the process chambers 110, 111.

Thus, methods and apparatus for a twin chamber processing system have been provided. The inventive twin chamber processing system advantageously combines resources, for example, such as a shared vacuum pump, shared gas panel or the like, to reduce system costs while maintaining processing quality in each chamber of the twin chamber processing system. Further, the inventive methods advantageous control operation of chamber processes, such as reducing pressure, venting, purging or the like, when shared resources are used between each chamber of the twin chamber processing system.

While the foregoing is directed to embodiments of the present invention, other and further embodiments of the invention may be devised without departing from the basic scope thereof.

1. A twin chamber processing system for processing substrates, comprising:
a first process chamber having a first vacuum pump for maintaining a first operating pressure in a first processing volume of the first process chamber, wherein the first processing volume can be selectively isolated by a first gate valve disposed between the first processing volume and a low pressure side of the first vacuum pump;
a second process chamber having a second vacuum pump for maintaining a second operating pressure in a second processing volume of the second process chamber, wherein the second processing volume can be selectively isolated by a second gate valve disposed between the second processing volume and a low pressure side of the second vacuum pump; and
a shared vacuum pump coupled to the first and second processing volumes for reducing a pressure in each processing volume below a critical pressure level prior to opening the first and second gate valves, wherein the shared vacuum pump can be selectively isolated from any of the first process chamber, the second process chamber, the first vacuum pump, or the second vacuum pump.

2. The twin chamber processing system of claim 1, further comprising:
a first roughing valve disposed between the first processing volume and the shared vacuum pump for selectively coupling the first processing volume to the shared vacuum pump while bypassing the first vacuum pump; and
a second roughing valve disposed between the second processing volume and the shared vacuum pump for selectively coupling the second processing volume to the shared vacuum pump while bypassing the second vacuum pump.

3. The twin chamber processing system of claim 2, further comprising:
a first isolation valve disposed between a high pressure side of the first vacuum pump and the shared vacuum pump for selectively coupling the first vacuum pump to the shared vacuum pump; and
a second isolation valve disposed between a high pressure side of the second vacuum pump volume and the shared vacuum pump for selectively coupling the second vacuum pump to the shared vacuum pump.

4. The twin chamber processing system of claim 1, further comprising:
a shared gas panel coupled to each of the first process chamber and the second process chamber for providing one or more process gases to the first and second process chambers.

5. The twin chamber processing system of claim 4, further comprising:
a first three-way valve disposed between the shared gas panel and the first process chamber to provide a process gas from the shared gas panel to the first processing volume of the first process chamber or to divert the process gas from the shared gas panel into a foreline conduit coupled to the shared vacuum pump; and
a second three-way valve disposed between the shared gas panel and the second process chamber to provide the process gas from the shared gas panel to the second processing volume of the second process chamber or to divert the process gas from the shared gas panel into a foreline conduit coupled to the shared vacuum pump.

6. The twin chamber processing system of claim 5, further comprising:
a first endpoint detector for detecting a process endpoint in the first process chamber; and
a second endpoint detector for detecting a process endpoint in the second process chamber.

7. The twin chamber processing system of claim 6, further comprising:
a controller configured to receive a first signal from the first endpoint detector when a process endpoint is reached in the first process chamber and to instruct the first three-way valve to divert a process gas into the foreline conduit if a process endpoint has not been reached for a process running in the second process chamber and to receive a second signal from the second endpoint detector when a process endpoint is reached in the second process chamber and to instruct the second three-way valve to divert a process gas into the foreline conduit if a process endpoint has not been reached for a process running in the first process chamber.

8. The twin chamber processing system of claim 6, further comprising:
a controller configured to receive a first signal from the first endpoint detector when a process endpoint is reached in the first process chamber and to turn off a first RF power source providing RF power to the first process chamber while continuing to flow a process gas from the shared gas panel to the first processing volume if a process endpoint has not been reached for a process running in the second process chamber and to receive a second signal from the second endpoint detector when a process endpoint is reached in the second process chamber and to turn off a second RF power source providing RF power to the second process chamber while continuing to flow a process gas from the shared gas panel to the second processing volume if a process endpoint has not been reached for a process running in the first process chamber.

9. The twin chamber processing system of claim 6, further comprising:
a controller configured to receive a first signal from the first endpoint detector and a second signal from the second endpoint detector when a process endpoint has been respectively reached for a process running in the first and second chambers and to instruct both process chambers to cease the process when either the first or second signal is received by the controller.

10. The twin chamber processing system of claim 6, further comprising:
a controller configured to receive a first signal from the first endpoint detector and a second signal from the second endpoint detector when a process endpoint has been respectively reached for a process running in the first and second chambers and to instruct both process chambers to cease the process when both the first or second signals is received by the controller.

11. A method of reducing pressure in each chamber of a twin chamber processing system to a desired operating pressure, comprising:
reducing a pressure of a first processing volume of a first process chamber of a twin chamber processing system below a critical pressure level using a shared vacuum pump coupled to the first processing volume and a second processing volume of a second process chamber of the twin chamber processing system, wherein the second processing volume is isolated from the first processing volume and the shared vacuum pump;
reducing a pressure in the first processing volume from below the critical pressure level to a first operating pressure using a first vacuum pump coupled to the first processing volume after the first processing volume is isolated from the shared vacuum pump;
opening the second processing volume to the shared vacuum pump after isolating the first processing volume having a pressure below the critical pressure level from the shared vacuum pump;
reducing the second processing volume of the second process chamber below the critical pressure level using the shared vacuum pump; and
reducing a pressure in the second processing volume from below the critical pressure level to a second operating pressure using a second vacuum pump coupled to the second processing volume after isolating the second processing volume from the shared vacuum pump.

12. The method of claim 11, further comprising:
isolating the first processing volume having the first operating pressure from a low pressure side of the first vacuum pump by closing a first gate valve disposed between the lower pressure side of the first vacuum pump and the first processing volume of the first process chamber;
isolating a high pressure side of the first vacuum pump from the shared vacuum pump by closing a first isolation valve disposed between a high pressure side of the first vacuum pump and the shared vacuum pump after the first gate valve is closed and the first vacuum pump is idled;
increasing a pressure in the first processing volume from the first operating pressure by providing a purge gas from a shared gas panel coupled to the first and second processing volumes;
isolating the second processing volume having the second operating pressure from a low pressure side of the second vacuum pump by closing a second gate valve disposed between the lower pressure side of the second vacuum pump and the second processing volume of the first process chamber;
isolating a high pressure side of the second vacuum pump from the shared vacuum pump by closing a second isolation valve disposed between a high pressure side of the second vacuum pump and the shared vacuum pump after the second gate valve is closed and the second vacuum pump is idled; and
increasing a pressure in the second processing volume simultaneously with increasing a pressure in the first processing volume by providing the purge gas from the shared gas panel to the second processing volume.

13. The method of claim 12, wherein increasing the pressure in the first processing volume from the first operating pressure further comprises:
opening a first purge valve disposed between the shared gas panel and the first processing volume; and
increasing the pressure in the first processing volume from the first operating pressure by providing the purge gas to the first processing volume via the first purge valve;
and wherein increasing the pressure in the second processing volume from the second operating pressure further comprises:
opening a second purge valve disposed between the shared gas panel and the second processing volume; and
increasing the pressure in the second processing volume from the second operating pressure by providing the purge gas to the second processing volume via the second purge valve.

14. The method of claim 13, further comprising:
venting the first processing volume to atmosphere after the purge gas is provided to the first processing volume; and
venting the second processing volume to atmosphere after the purge gas is provided to the second processing volume.

15. The method of claim 12, further comprising:
isolating the second processing volume having the second operating pressure from a low pressure side of the second vacuum pump by closing a second gate valve disposed between the lower pressure side of the second vacuum pump and the second processing volume of the first process chamber;
isolating a high pressure side of the second vacuum pump from the shared vacuum pump by closing a second isolation valve disposed between a high pressure side of the second vacuum pump and the shared vacuum pump after the second gate valve is closed and the second vacuum pump is idled; and
reducing a pressure in the first processing volume to below the critical pressure level by removing the purge gas from the first processing volume by opening a first roughing valve disposed between the first processing volume and the shared vacuum pump.

16. The method of claim 15, further comprising:
increasing a pressure in the second processing volume from the second operating pressure by providing the purge gas from the shared gas panel to the second processing volume while simultaneously reducing the pressure in the first processing volume to below the critical pressure level by removing the purge gas.

17. The method of claim 16, further comprising:
closing the first roughing valve after removing the purge gas from the first processing volume; and
reducing a pressure in the second processing volume to below the critical pressure level by removing the purge gas from the second processing volume by opening a second roughing valve disposed between the second processing volume and the shared vacuum pump after the first roughing valve is closed.

18. The method of claim 16, further comprising:
increasing a pressure in the first processing volume from below the critical pressure by providing the purge gas to the first processing volume during a second iteration while reducing the pressure in the second processing volume to below the critical pressure level by removing the purge gas.

19. The method of claim 18, further comprising:
closing the second roughing valve after removing the purge gas from the second processing volume; and
reducing a pressure in the first processing volume to below the critical pressure level by removing the purge gas from the first processing volume during the second iteration by opening the first roughing valve disposed between the first processing volume and the shared vacuum pump.

20. The method of claim 19, further comprising:
increasing a pressure in the second processing volume from below the critical pressure level by providing the purge gas to the second processing volume during the second iteration while simultaneously reducing the pressure in the first processing volume to below the critical pressure level by removing the purge gas during the second iteration.
